(19) United States
(12) Patent Application Publication
(10) Pub. No.: US 2023/0335006 A1
(43) Pub. Date: Oct. 19, 2023

(54) Robotic Head For Modeling Articulation Of Speech Sounds

(71) Applicant: Annunciation Corporation, Clinton, NJ (US)

(72) Inventors: Paige DiGiambattista, Annandale, NJ (US); Gregory W. Weaver, Morganville, NJ (US)

(73) Assignee: Annunciation Corporation, Clinton, NJ (US)

(21) Appl. No.: 17/720,979

(22) Filed: Apr. 14, 2022

(51) Int. Cl. G09B 19/04; G10L 15/22; G06F 3/0482; G06F 3/0488; G06F 3/16; G09B 23/32; G09B 5/06

(52) U.S. Cl. CPC G09B 19/04; G10L 15/22; G06F 3/0482; G06F 3/0488; G06F 3/165; G09B 23/32; G09B 5/06; G10L 2015/223

(57) ABSTRACT

A robotic head for modeling the articulation of speech sounds, including a three-dimensional head section, a moveable tongue, upper and lower lips, and jaw, and at least one actuator for moving them. A memory stores a plurality of motion command sets, each being a predetermined set of commands for moving one or more of the tongue, lips, and jaw in a manner that corresponds to generation of a specific speech sound. In response to receipt of a speech sound input command that identifies a requested speech sound, a processor transmits the commands of the motion command set corresponding to the requested speech sound to the at least one actuator to move the tongue, lips, and jaw in a manner that corresponds to generation of the requested speech sound. The three-dimensional head is made of transparent material such that the tongue is viewable by a patient when moved.

### FIELD OF THE INVENTION

The present invention relates to a speech therapy aid. More specifically, the invention relates to a robotic head for modeling the anatomical movements necessary to articulate different speech sounds.

### BACKGROUND OF THE INVENTION

Vocalized speech is a critical part of human communication. Spoken words are created out of the phonetic combination of a limited set of vowels and consonants that, when verbalized, generate various specific speech sounds.

Unfortunately, millions of people are affected by language disorders, including speech sound or articulation disorders. Those with such disorders typically have difficulty learning how to physically produce the intended phonemes, or in other words, have difficulty making certain speech sounds. As just one example, an individual suffering from an articulation disorder, when intending to make an “r” sound, may instead make a “w” sound, and as a result, will speak the word “rabbit” as “wabbit.”

Often, articulation disorders are a result of incorrect positioning and/or movement of the tongue, lips, and jaw. The speaker may find it difficult to visualize the correct location of these anatomical parts, and therefore, intervention by a professional who can employ speech therapy is often required to help teach the speaker how to orient the tongue and other parts of the mouth.

Such speech therapy often entails instructing the affected individual regarding the proper positioning of the jaw, lips, and tongue when making the different audible phonetic sounds necessary for effective verbal communication. For example, when making an M, B, or P sound, the mouth is closed and the lips are pursed in a manner that conceals the teeth. However, when making a V or F sound, the mouth is closed, but the lips are slightly parted in a manner which leaves the teeth slightly exposed. Moreover, when making a “TH” sound, the lips are slightly open, but the tongue is placed in contact with the apical tips of the upper central incisor teeth.

Over the years, various techniques have been employed to try to elicit the production of specific speech sounds, including mirrors for visual feedback, gestural hand cueing to demonstrate place and manner of production, palatography to record/visualize contact of the tongue on the palate, amplifying target sounds to reduce distraction and improve attention, using acoustic feedback, such as recordings of the client's speech, and providing tactile biofeedback, using tools like tongue depressors to correct tongue placement. Nevertheless, it is often difficult for the speech pathologist to physically demonstrate to the person receiving the speech therapy the proper relative positioning of the mouth, lips, teeth and tongue for each of the required speech sounds.

Proper tongue formation, for example, requires fine muscular coordination. Teaching proper tongue formation without the help of mechanical aids typically amounts to the speech therapist repeatedly instructing the individual to shape his/her tongue in the proper manner, and having the individual repeatedly try to follow these directions, while also listening to their own speech as they do so, in order to see if he/she generates the proper sound. Using this process, it can be quite difficult for the individual to visualize the proper execution of the directions they are receiving.

Therefore, various types of speech therapy aids have been employed over the years to help visually demonstrate the relative positioning of the mouth, lips, teeth, and tongue to affected individuals attempting to learn how to generate certain speech sounds.

Some of these devices are positioned in the mouth of the speaker and then visually demonstrate the effects of anatomical movements as the speaker practices pronouncing the relevant speech sound. For example, U.S. Pat. No. 3,867,770 to Davis discloses an older device for teaching proper tongue and mouth formation to correct various speech problems. This device captures and isolates the air expelled from different parts of the speaker's mouth, and it visually indicates the magnitude of air expelled from each part of the mouth. Through trial and error, the speaker can visually observe how different articulations of his/her tongue change the sounds that are produced.

In other cases, these devices attempt to mimic the actual anatomical movements themselves. For example, U.S. Pat. No. 5,662,477 to Miles relates to a puppet for demonstrating the preferred positioning of oral anatomical structures (e.g., mouth, tongue, hard palate, incisor teeth) when making various speech sounds. The device includes a puppet body into which a user inserts a hand, and which has various digit-receiving spaces in the tongue and jaw, such that the user's hand may be moved or manipulated so as to cause selective movement of these parts of the puppet when making certain phonetic sounds.

However, as noted above, proper pronunciation of various different speech sounds involves simultaneous, very sophisticated movements and positioning of multiple anatomical parts to produce one speech sound rather than another. The aforementioned devices all fail to adequately demonstrate this fine muscle coordination and precise positioning in concert with the audible production of the relevant speech sounds. These speech therapy devices are often difficult and time-consuming to use, and they tend to be fairly ineffective.

What is desired, therefore, is a speech therapy aid that will visually demonstrate the precise positioning of anatomical parts for generating individual speech sounds. What is further desired is a speech therapy aid that audibly produces the relevant speech sound while this is being demonstrated. What is also desired is such a speech therapy device that is easy to use.

### SUMMARY OF THE INVENTION

Accordingly, it is an object of the present invention to provide a speech therapy aid that teaches the proper movement and positioning of the tongue, lips, and jaw for producing specific, desired speech sounds.

It is also an object of the present invention to provide a speech therapy aid that demonstrates such movement using artificial versions of these parts that closely resemble the human anatomy.

It is a further object of the present invention to provide such a speech therapy aid that audibly produces the relevant speech sound while visually demonstrating the movements corresponding to that sound.

It is still another object of the present invention to provide a speech therapy aid that is easy to use.

In order to overcome the deficiencies of the prior art and to achieve at least some of the objects and advantages listed, the invention comprises a robotic head for modeling the articulation of speech sounds, including a three-dimensional head section representing the anatomy of at least part of a human head, a moveable tongue portion, moveable upper and lower lip portions, and a moveable jaw portion, at least one actuator for moving the tongue portion, lip portions, and jaw portion, a memory storing a plurality of motion command sets, each motion command set being a predetermined set of commands for moving one or more of the tongue portion, lip portions, and jaw portion in a manner that corresponds to generation of a speech sound different from the speech sounds corresponding to other of the motion command sets, and a processor that, in response to receipt of a speech sound input command that identifies a requested speech sound, transmits the commands of the motion command set corresponding to the requested speech sound stored in the memory to the at least one actuator to move one or more of the tongue portion, lip portions, and jaw portion in a manner that corresponds to generation of the requested speech sound, and wherein the three-dimensional head section is a transparent material such that the tongue portion is viewable by a patient when moved in response to the at least one actuator receiving the commands of the motion command set corresponding to the requested speech sound.

In certain advantageous embodiments, the plurality of motion command sets stored in the memory includes two or more of a first set of commands for moving one or more of the tongue portion, lip portions, and jaw portion in a manner that corresponds to generation of a first vowel sound, a second set of commands for moving one or more of the tongue portion, lip portions, and jaw portion in a manner that corresponds to generation of a second vowel sound different from the first vowel sound, a third set of commands for moving one or more of the tongue portion, lip portions, and jaw portion in a manner that corresponds to generation of a first consonant sound, a fourth set of commands for moving one or more of the tongue portion, lip portions, and jaw portion in a manner that corresponds to generation of a second consonant different from the first consonant sound.

In some embodiments, the plurality of motion command sets stored in the memory includes a first set of commands for moving one or more of the tongue portion, lip portions, and jaw portion in a manner that corresponds to generation of a bilabial sound, a second set of commands for moving one or more of the tongue portion, lip portions, and jaw portion in a manner that corresponds to generation of a labio-dental sound, a third set of commands for moving one or more of the tongue portion, lip portions, and jaw portion in a manner that corresponds to generation of an inter-dental sound, a fourth set of commands for moving one or more of the tongue portion, lip portions, and jaw portion in a manner that corresponds to generation of a alveolar sound, a fifth set of commands for moving one or more of the tongue portion, lip portions, and jaw portion in a manner that corresponds to generation of a post-alveolar sound, a sixth set of commands for moving one or more of the tongue portion, lip portions, and jaw portion in a manner that corresponds to generation of a palatal sound, and a seventh set of commands for moving one or more of the tongue portion, lip portions, and jaw portion in a manner that corresponds to generation of a velar sound. In certain embodiments, the memory includes all of these sets of commands

In certain embodiments, the invention further comprises a control box on which the three-dimensional head section is mounted, the control box including the memory and the processor therein, a display that displays a plurality of textual representations of the speech sounds corresponding to the plurality of motion command sets, such that the requested speech sound can be selected from the plurality of textual representations, an input for generating the speech sound input command that identifies the requested speech sound, and an audio output for audibly producing the requested speech sound in response to the speech sound input command.

In some of these embodiments, the input includes a manual control with which the requested speech sound can be selected from the plurality of textual representations on the display. In other embodiments, the display includes a touch screen, the touch screen having the input for generating the speech sound input command that identifies the requested speech sound.

In certain advantageous embodiments, the display also displays an option to select a number of times the speaker will audibly produce the requested speech sound in response to the speech sound input command.

In some embodiments, the invention further comprises a control box on which the three-dimensional head section is mounted, the control box having a receiver for wireless communication with a mobile device, and software executing on the mobile device that displays a plurality of textual representations of the speech sounds corresponding to the plurality of motion command sets, such that the requested speech sound can be selected from the plurality of textual representations and, when selected, the speech sound input command that identifies the requested speech sound is transmitted to the control box. In some cases, the software executing on the mobile device also displays an option to select a number of times the requested speech sound will be audibly produced in response to the speech sound input command

In certain embodiments, the at least one actuator includes first and second tongue servomotors coupled to the moveable tongue portion, first and second lip servomotors coupled to the moveable upper and lower lip portions, respectively, and at least one jaw servomotor coupled to the moveable jaw portion.

In some cases, the invention further includes a control box on which the three-dimensional head section is mounted, and a support frame connected to the control box, wherein the first and second tongue servomotors, first and second lip servomotors, and at least one jaw servomotor are mounted to the frame.

In certain advantageous embodiments, the invention includes a cover connected to the control box, the cover at least partially enclosing a chamber in which the support frame is disposed. In some embodiments, the cover is made of an opaque material that obscures the frame, first and second tongue servomotors, first and second lip servomotors, and at least one jaw servomotor from view. In some cases, the cover includes a first portion connected to the control box, and a second portion hingedly connected to the first portion of the cover such the second portion is moveable from a first position, in which the first and second tongue servomotors, first and second lip servomotors, and at least one jaw servomotor are from hidden from view, to a second position, in which the first and second tongue servomotors, first and second lip servomotors, and at least one jaw servomotor are manually accessible by a user.

In some embodiments, the at least one actuator includes first and second tongue servomotors, and the moveable tongue portion includes a channel therein, and the invention further includes a support frame to which the first and second tongue servomotors are mounted, a flexing band disposed in the channel, the flexing band having a first end mounted to the support frame, and a second end adjacent a distal end of the tongue portion, a first string disposed in the channel, the first string having a first end coupled to the first tongue servomotor, and a second end coupled to the second end of the flexing band, such that the tongue moves upwardly when the first tongue servomotor pulls on the first string, and a second string disposed in the channel, the second string having a first end coupled to the second tongue servomotor, and a second end coupled to the second end of the flexing band, such that the tongue moves downwardly when the second tongue servomotor pulls on the second string. In some of these embodiments, the flexing band is a spring steel band.

In certain embodiments, the at least one actuator includes first and second lip servomotors, and the invention further includes a support frame to which the first and second lip servomotors are mounted, an upper denture portion and a lower denture portion, each denture portion having a plurality of protuberances along an outer edge thereof, each protuberance having an aperture therein, an upper flexing band having a first end coupled to the first lip servomotor, the upper flexing band passing through the apertures of the protuberances along the outer edge of the upper denture portion, and having a second end affixed to a proximal end of the upper denture portion, wherein a distal section of the upper flexing band member is affixed to the moveable upper lip portion such that, when the first lip servomotor pulls the upper flexing band member, the upper lip portion is pulled inwardly, and a lower flexing band having a first end coupled to the second lip servomotor, the lower flexing band passing through the apertures of the protuberances along the outer edge of the lower denture portion, and having a second end affixed to a proximal end of the lower denture portion, wherein a distal section of the lower flexing band member is affixed to the moveable lower lip portion such that, when the second lip servomotor pulls the lower flexing band member, the lower lip portion is pulled inwardly. In certain of these embodiments, when the first lip servomotor pushes the upper flexing band member, the upper lip portion is pushed outwardly, and when the second lip servomotor pushes the lower flexing band member, the lower lip portion is pushed outwardly. In some cases, the upper flexing band and the lower flexing band are spring steel bands.

In some embodiments, the at least one actuator includes a jaw servomotor, and the invention further includes a support frame to which the jaw servomotor is mounted, the jaw portion having a support member pivotably connected to the frame, and a lower denture portion affixed to the support member, and the jaw servomotor is coupled to the support member by linkage such that, when the servomotor pulls the linkage, the support member and lower denture portion pivot downwardly.

### BRIEF DESCRIPTION OF THE DRAWINGS

FIG. 1 is a front perspective view of a speech therapy aid according to the invention.

FIG. 2 is a rear perspective view of the speech therapy aid of FIG. 1.

FIG. 3 is a front elevational view of the speech therapy aid of FIGS. 1-2.

FIG. 4 is a side elevational view of the speech therapy aid of FIGS. 1-2.

FIG. 5 is a top view of the speech therapy aid of FIGS. 1-2.

FIG. 6 is an exploded, perspective view of an alternate version of the head and frame sections of the speech therapy aid of FIGS. 1-5.

FIG. 7 is a front perspective view of a speech therapy aid employing the head and frame sections of FIG. 6.

FIG. 8 is a rear perspective view of the speech therapy aid of FIG. 7 with an open frame cover.

FIG. 9 is a front elevational view of the speech therapy aid of FIG. 7.

FIG. 10 is a side elevational view of the speech therapy aid of FIG. 7.

FIG. 11 is a top view of the speech therapy aid of FIG. 7.

FIG. 12 is a front perspective view of the frame of the speech therapy aid of FIG. 7

FIG. 13 is a rear perspective view of the frame of FIG. 12.

FIG. 14 is a front perspective view of the frame of FIGS. 12-13 with servomotors and upper and lower denture portions attached thereto.

FIG. 15 is a rear perspective view of the frame of the assembly of FIG. 14.

FIG. 16 is a front elevational view of the assembly of FIGS. 14-15.

FIG. 17 is a side elevational view of the assembly of FIGS. 14-15.

FIG. 18 is a rear elevational view of the assembly of FIGS. 14-15.

FIG. 19 is a top view of the assembly of FIGS. 14-15.

FIG. 20 is a side elevational view of the assembly of FIG. 17, with the jaw portion in an opened position.

FIG. 21 is a side elevational view of the assembly of FIG. 17, employing a spring steel spring band along the upper and lower denture portions connected to linkage connecting a rotating member.

FIG. 22 is a side elevational view of the assembly of FIG. 17, employing a band directly connected to a rotating member.

FIG. 23 is a side elevational view of the assembly of FIG. 22, with the upper lip in a retracted position.

FIG. 24 is a left side elevational view of the assembly of FIG. 22, with the upper lip in an extended position.

FIG. 25 is a right side elevational view of the assembly of FIG. 22, with the upper lip in an extended position.

FIG. 26 is a side elevational view of the assembly of FIG. 22, with the lower lip in a retracted position.

FIG. 27 is a left side elevational view of the assembly of FIG. 22, with the lower lip in an extended position.

FIG. 28 is a front elevational view of the frame of FIGS. 12-13 with servomotors and upper and lower denture portions attached thereto.

FIG. 29 is a side elevational view of the assembly of FIG. 28 with a tongue portion connected thereto and in an at rest position.

FIG. 30 is a side elevational view of the assembly of FIG. 29, with the tongue portion in a curled-up position.

FIG. 31 is a side elevational view of the assembly of FIG. 29, with the tongue portion in a curled down position.

FIG. 32 is a flow chart illustrating the operation of part of the speech therapy aid of FIG. 7.

FIGS. 33A-B are schematic profile views of the head and tongue.

FIGS. 34A-S are schematic profile views of different positions for the jaw, lip, and tongue portions of FIGS. 20-31.

FIG. 35 is front views of different positions for the lip portions of FIGS. 22-27.

### DETAILED DESCRIPTION OF THE INVENTION

The following detailed description illustrates the technology by way of example, not by way of limitation, of the principles of the invention. This description will enable one skilled in the art to make and use the technology, and describes several embodiments, adaptations, variations, alternatives and uses of the invention, including what is presently believed to be the best mode of carrying out the invention. One skilled in the art will recognize alternative variations and arrangements, and the present technology is not limited to those embodiments described hereafter.

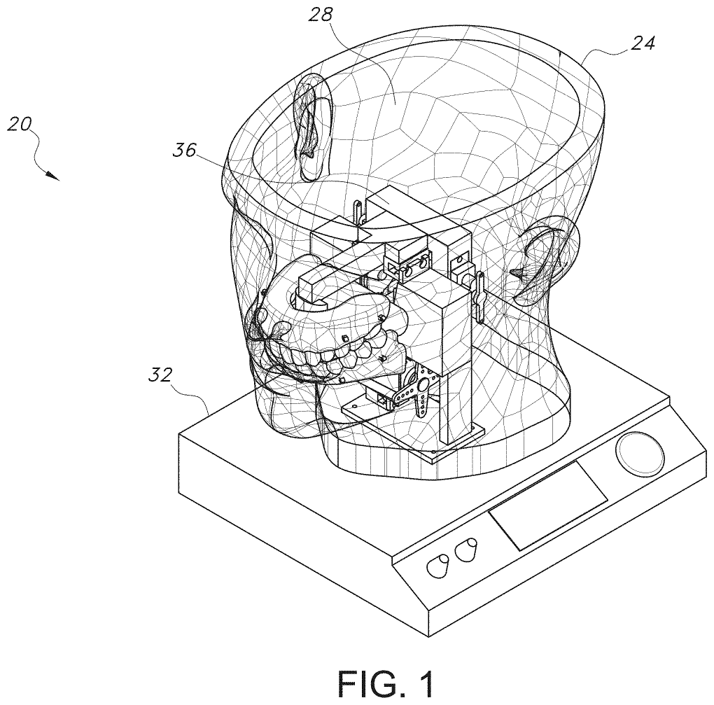

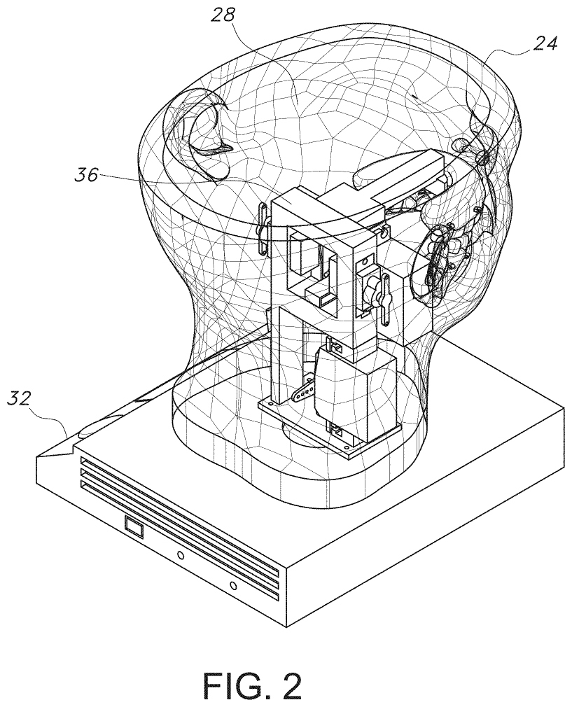

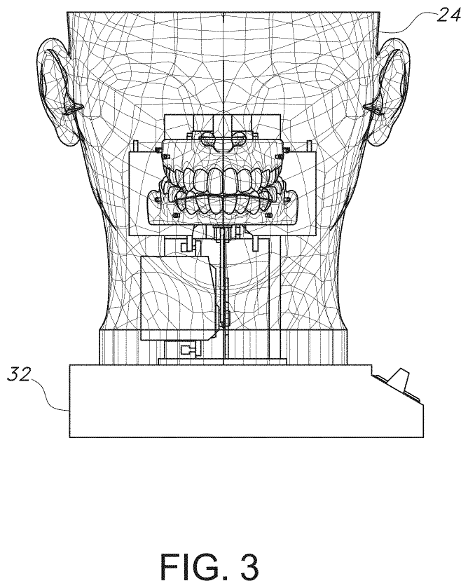

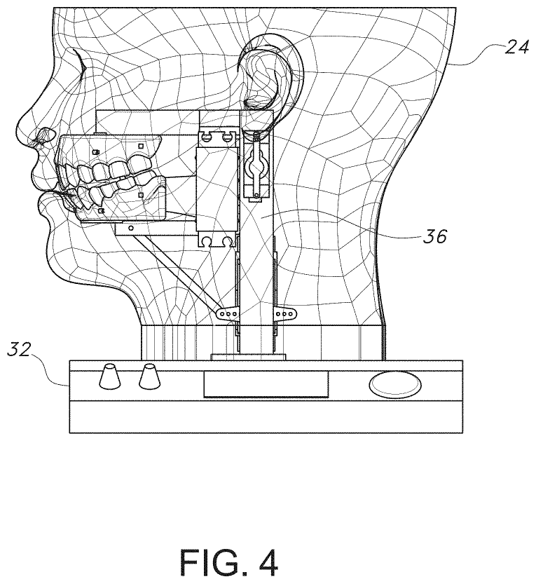

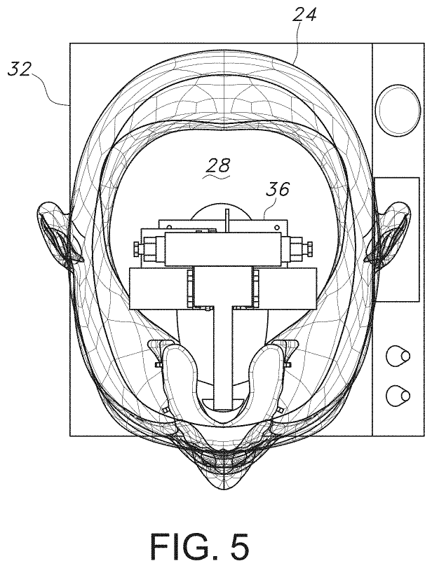

FIGS. 1-5 illustrate one exemplary embodiment of a device (20) in accordance with the invention. A three-dimensional head section (24) represents at least part of a human head. In this embodiment, a significant portion of the head is replicated, such that an entire human face is represented. However, in other embodiments, more or less of the anatomy may be shown. For example, in some cases, an entire human head can be replicated, and in others, the head section may primarily correspond to the mouth and jaw, as shown in an embodiment discussed further below. Regardless, the head section (24) at least partially encloses a head cavity (28).

The head section (24) is mounted to a base in the form of a control box (32), discussed in further detail below. A support frame (36), which in this embodiment is positioned within the head cavity (28), is also mounted to the control box (32). The frame (36) supports various actuators and mechanical linkages that operate the anatomical portions of the head, as is also discussed further below.

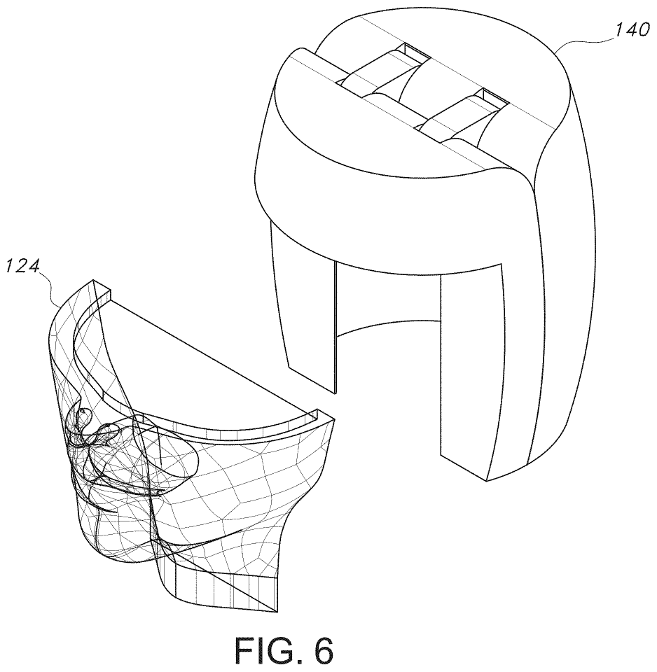

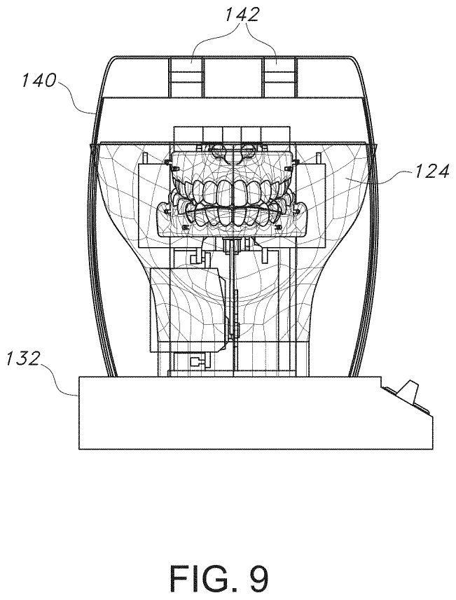

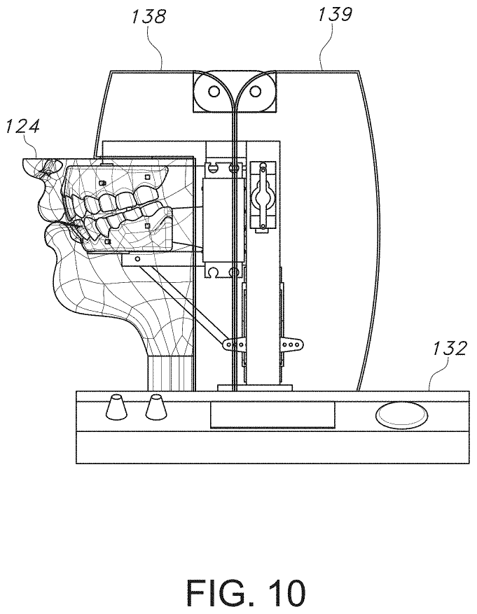

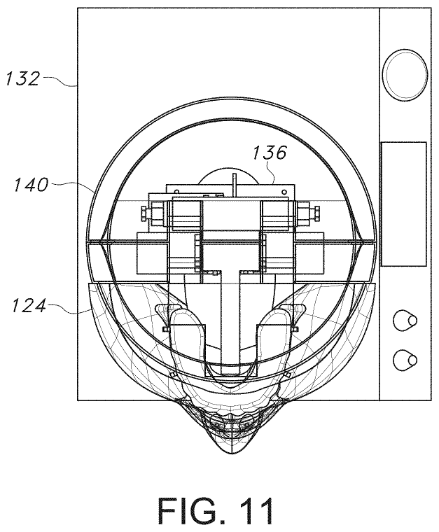

FIGS. 6-11 illustrate a modified version of the above-described embodiment. As shown in FIG. 6, in this embodiment, only the lower anatomy of the head is replicated. Here, the three-dimensional head section (124) comprises primarily the mouth, chin, and neck. As such, the device (120) can be employed to demonstrate movement of the jaw, lips and tongue, as discussed further below.

The head section (124) comprises clear, grade 1 silicone, and thus, is somewhat malleable in order to accommodate the various movements discussed herein. The head is transparent so that the individual receiving the speech therapy is able to see through the head section (124) to view the various positions of the tongue and other parts of the mouth.

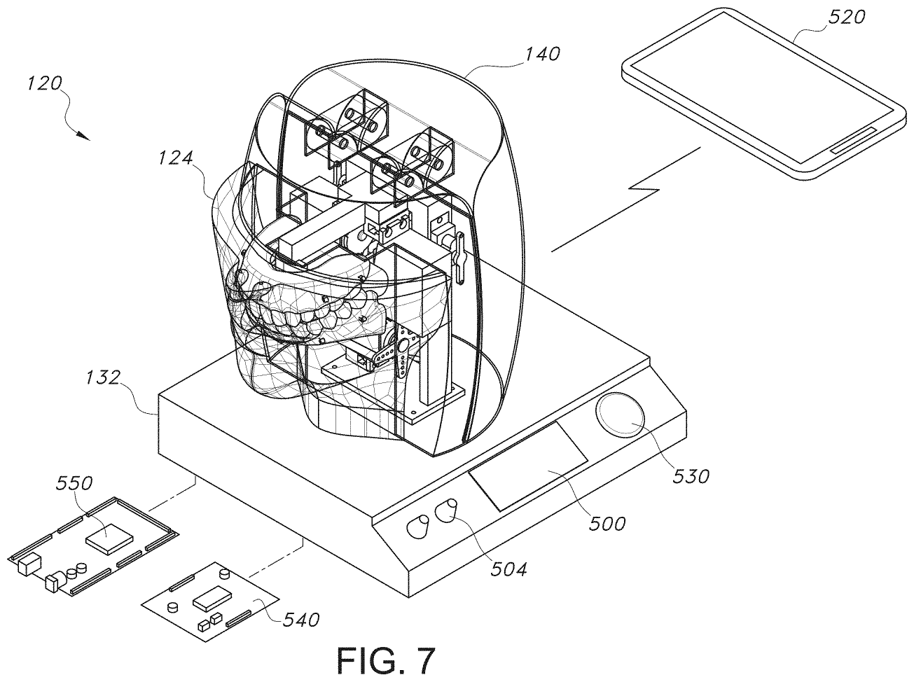

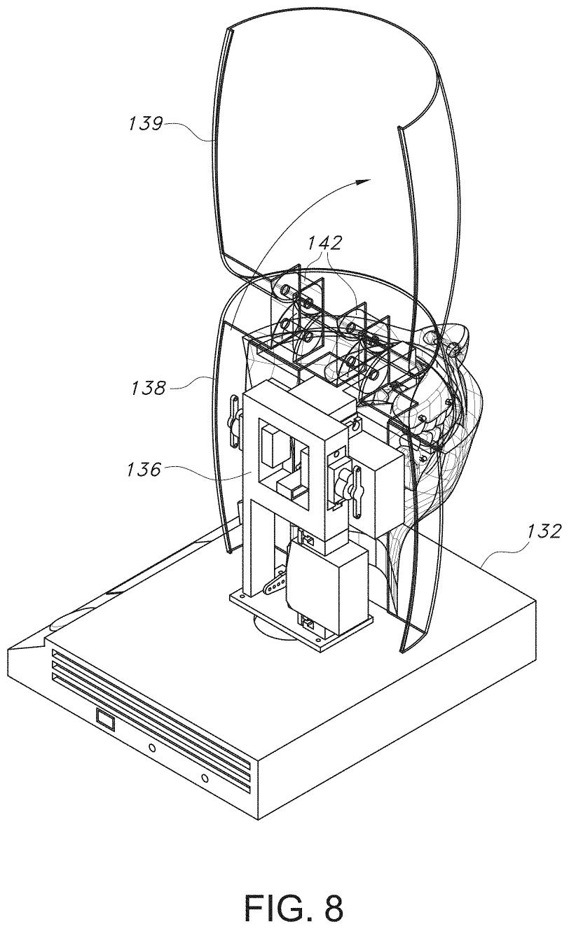

Referring to FIGS. 7-8, a support frame (136) is housed in a cover (140). Though illustrated as transparent for clarity, it should be noted that the cover (140) is typically opaque, thereby shielding the frame (136) and any components mounted thereto from view.

The frame (136) and cover (140) are mounted to the control box (132). The cover (140) includes first and second portions (138, 139), which are pivotably connected by at least one hinge (142). Accordingly, the second portion (139) may be pivoted into an open position (FIG. 8), such that any servomotors, wires, and linkages mounted or connected to the frame (136) are accessible for service, repair, or replacement.

As shown most clearly in FIG. 6, the head portion (124) mates with the cover (140) and may be secured thereto. In some embodiments, the head portion (124) is independently mounted to the control box (132).

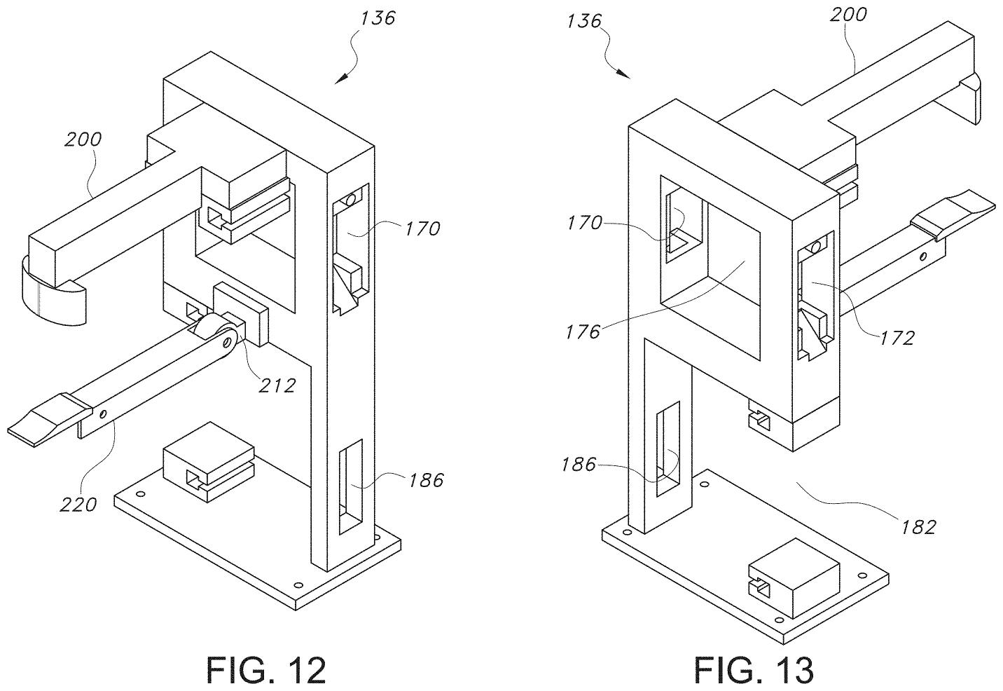

As shown in FIGS. 12-13, the support frame (136) includes a number of apertures (170, 172, 173, 176, 182) for accommodating various actuators for actuating the various anatomical parts discussed herein.

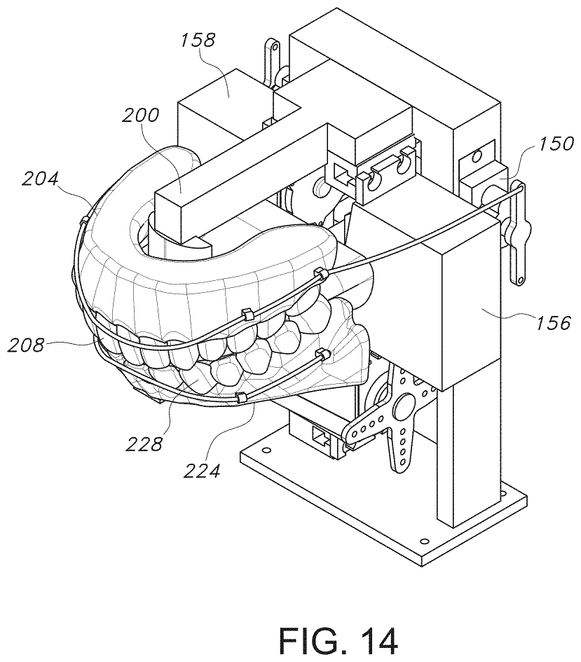

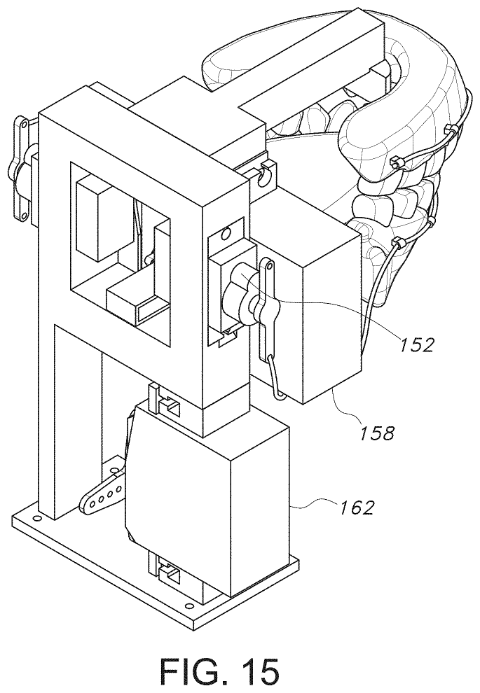

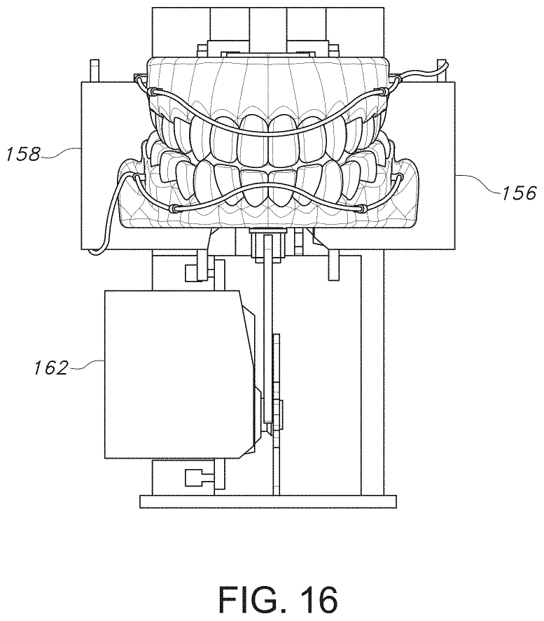

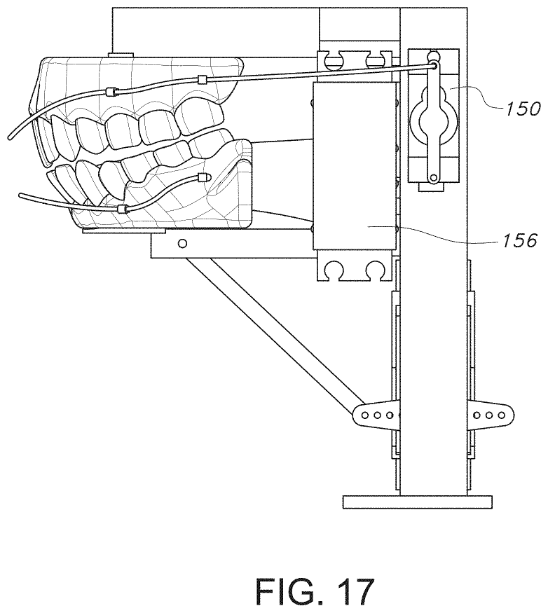

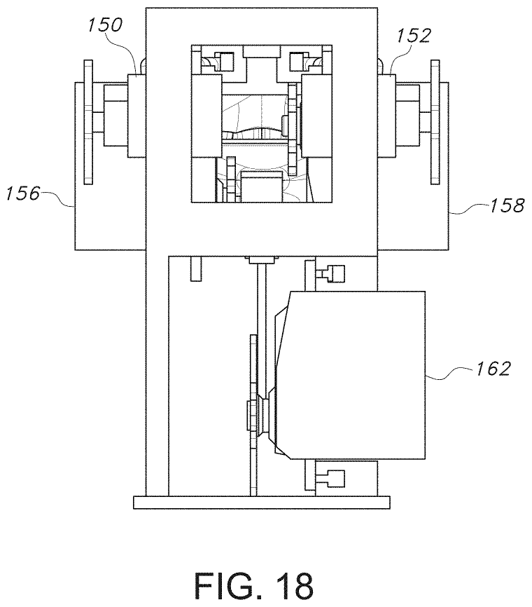

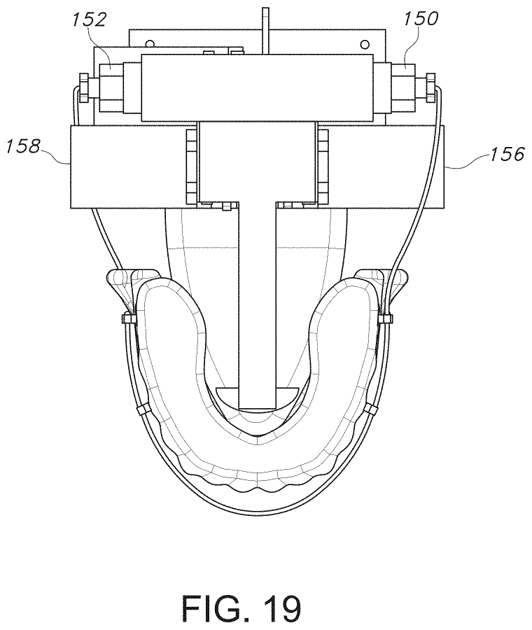

Referring to FIGS. 14-19, in this particular embodiment, two small servomotors (150, 152), such as 9g micro servos, are press fit into frame apertures (170, 172), respectively, and are used to actuate the lips. Two larger servomotors (156, 158), such as 55g high torque servo, are mounted at the front of the large opening (176) and are used to actuate the tongue. A similar large servomotor (162) is mounted in lower aperture (182) and is used to actuate the jaw. In some embodiments, another small servomotor is mounted in an aperture (186) as a redundant actuator for the lower jaw. The construction and movement of these various anatomical parts are detailed further below.

As noted above, the frame (136), and the components mounted thereto, are at least partially enclosed by the cover housing (140). In the example shown, the housing (140) accommodates the frame (136), servomotors (150, 152, 156, 158, 162), and part of the linkages coupling the servomotors to the anatomical portions discussed above. This serves several purposes. Because the head portion (124) is made of a transparent material in order to facilitate viewing of the moving anatomical portions discussed above, the cover (140) can be fashioned out of an opaque material that hides the frame (136) and components thereon from the viewer. First, this provides a more attractive, sleek look, which is highly desirable in clinical settings. More importantly, as speech therapy patients are often children who would easily be distracted by moving parts such as spinning motor shafts and pivoting linkages, these components are largely shielded from view by the cover (140), allowing the patient to remain focused on the moving anatomical parts.

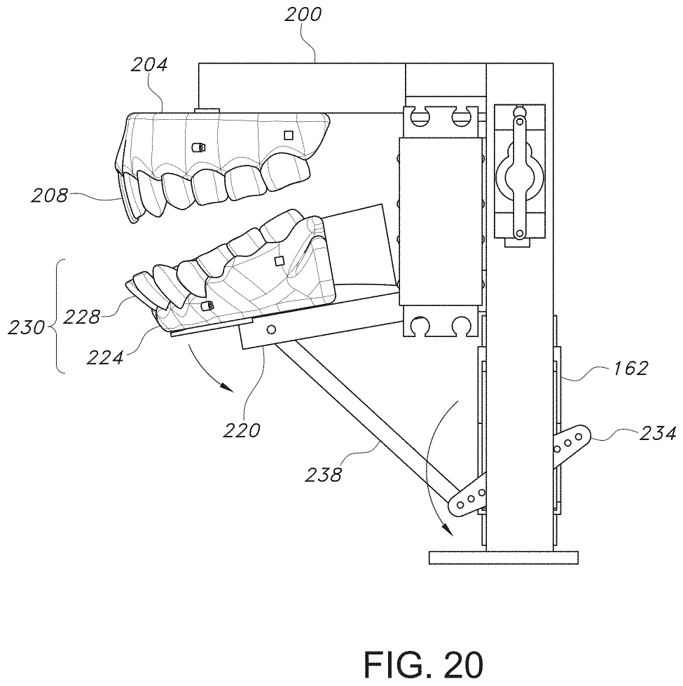

As illustrated in FIG. 20, movement of a jaw portion (230) is shown. The frame (136) includes an upper support member (200) protruding outwardly therefrom. An upper denture portion (204), which includes a plurality of teeth (208), is connected to the member (200).

The jaw portion (230) includes a lower support member (220). Referring back to FIG. 12, the frame (136) includes a mount (212), to which the lower support member (220) is pivotably connected, such that the member (220) pivots downwardly. Returning to FIG. 20, a lower denture portion (224), which also includes a plurality of teeth (228), is mounted on the pivoting support member (220), such that this lower denture portion (224) likewise pivots downwardly, thereby producing the jaw portion (230) that can be opened.

The opening of the jaw portion (230) is achieved via the large servomotor (162), which drives a rotating member (234). Rotating member (234) is coupled to linkage rod (238), which in turn, is coupled to the underside of pivoting member (220). As a result, the jaw portion (230), comprised of the pivoting member/lower denture assembly (220, 224), can be opened to a specific, predetermined degree by rotating the member (234) by the corresponding amount.

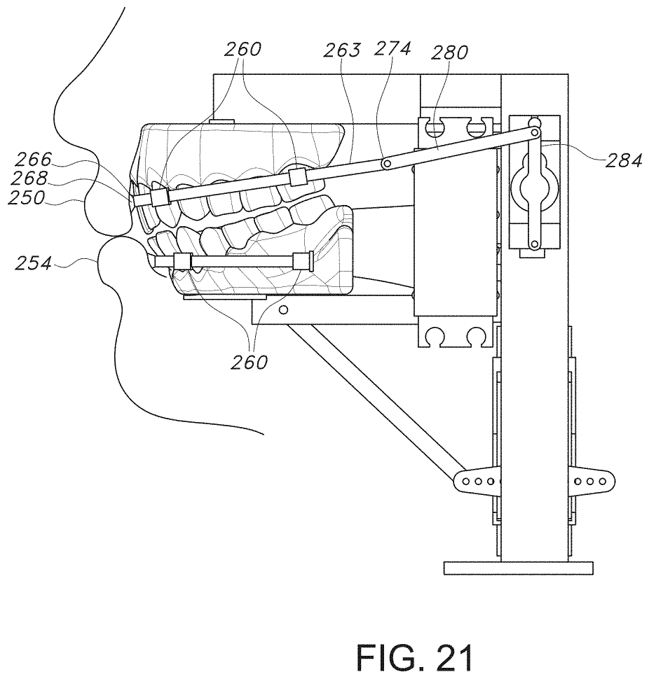

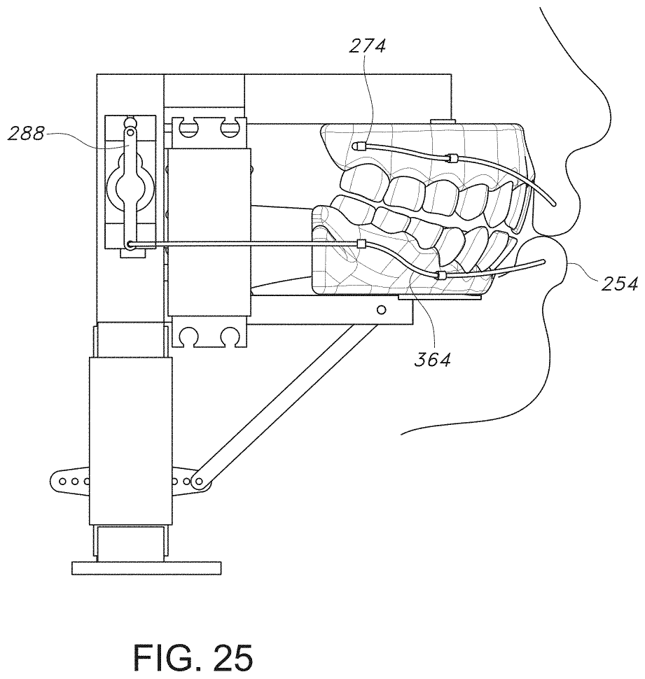

Referring to FIGS. 21-27, the movement of upper and lower lip portions (250, 254) are shown. The upper denture portion (204) includes a plurality of slotted protrusions (260) along its outer edge. In the illustrated embodiments, there are four such protrusions, including one on each side at the rear, and one on each side behind the fourth tooth from the front. The protrusions (260) act as guides for an upper flexing band (263).

In certain advantageous embodiments, the band (263) comprises a spring steel band, shown in FIG. 21. A first end of the flexing band (263) is secured in one of the rear guides (260). The band (263) extends around the outer periphery of the upper denture portion (204), and the second end (274) of the flexing band is coupled to a linkage rod (280) having an eyelet therein at its distal end, and this linkage (280) is in turn coupled to a rotating member (284), also having an eyelet at its end for connecting to the linkage (280). At the distal tip (266) of the curved band (263), the band is fastened to the inside of the upper lip portion (250) with a suitable bonding agent (268), such as 405 nm resin.

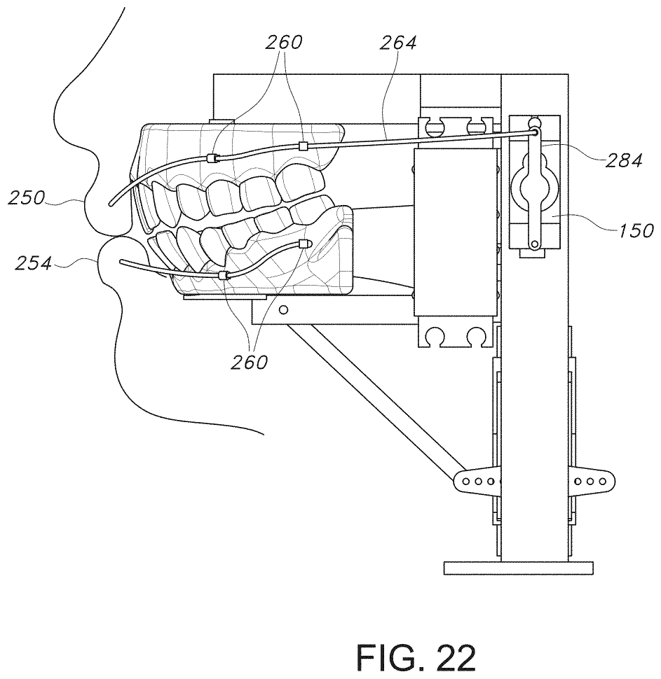

Alternatively, other types of bands or wires may be employed. Additionally, other bands or wires (264) may also be directly connected to the rotating member (284), and may also penetrate, or be molded or otherwise embedded in, the lip portion (250), as is shown in FIG. 22-27.

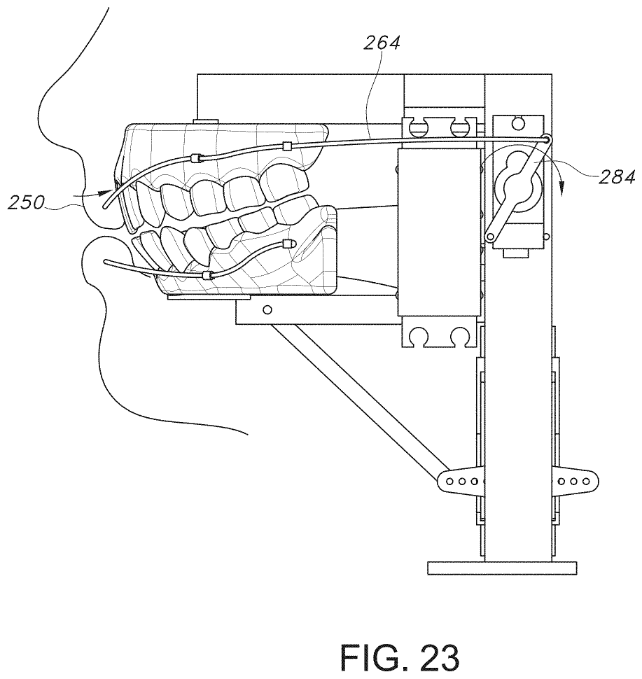

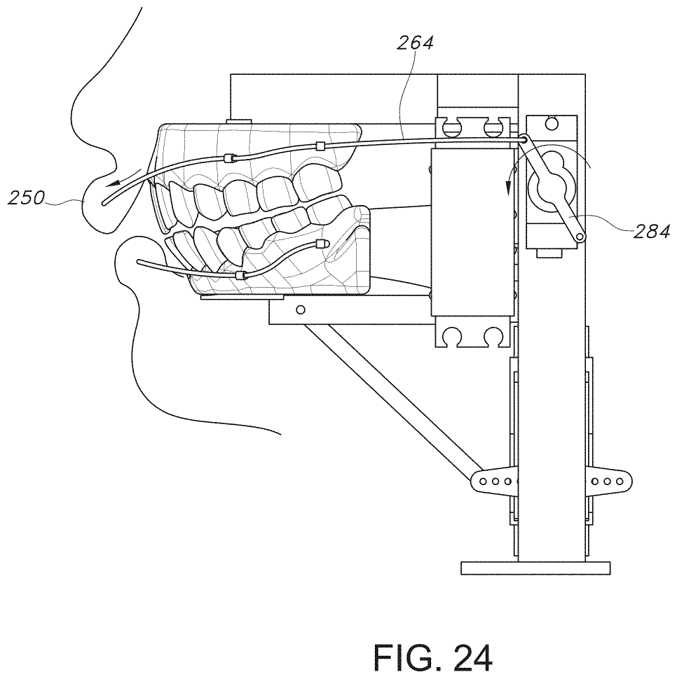

Movement of the upper lip portion (250) is achieved via the small servomotor (150), which faces outwardly from the frame (136) and drives the rotating member (284). As shown in FIGS. 23-24, when member (284) rotates in one direction, it pulls the band (264), and because the band (264) is connected with the upper lip portion (250), this pulls back the lip. As a result, the upper lip portion (250) can be retracted back to a specific, predetermined amount by rotating member (284) accordingly. Likewise, when member (284) rotates in the other direction, it pushes the band (264), and thus, extends the lip outwardly.

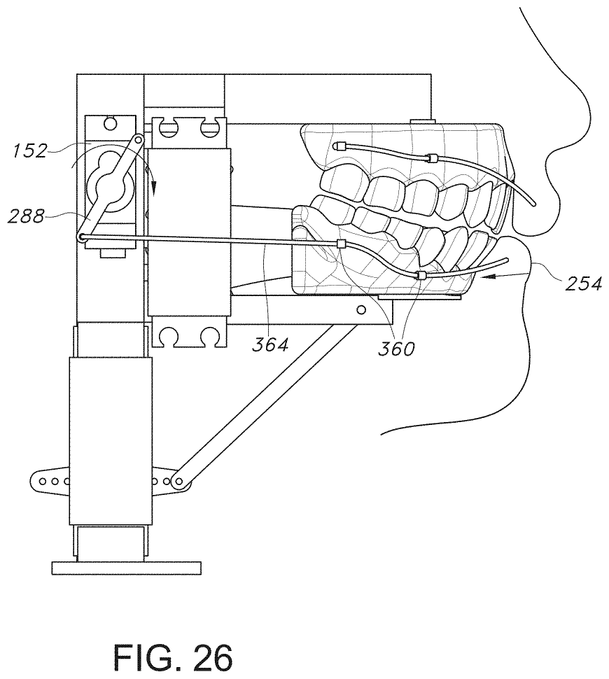

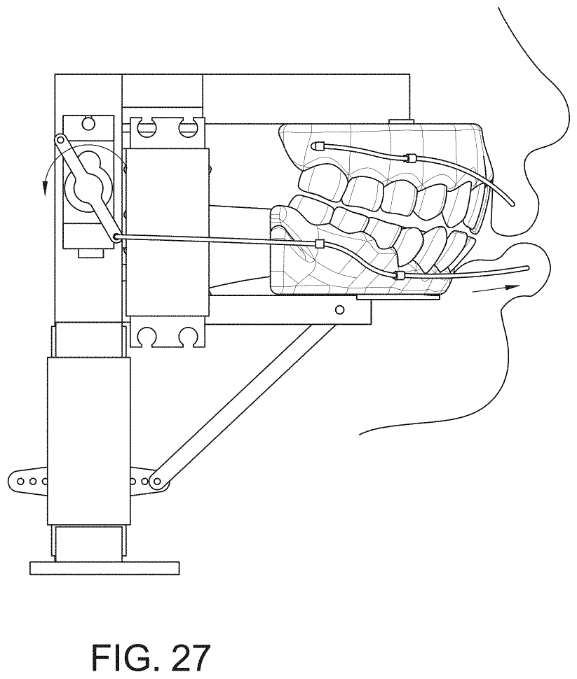

In similar fashion, as shown in FIGS. 26-27, the lower denture portion (224) includes a plurality of slotted protrusions (360) along its outer edge. In the illustrated embodiment, there are four such protrusions, including one on each side at the rear, and one on each side behind the fourth tooth from the front. The protrusions (360) act as guides for a lower flexing band (364).

The lower flexing band (364) may be arranged in any of the manners described above for the upper flexing band. Movement of the lower lip portion (254) is achieved via the small servomotor (152), which also faces outwardly, on the opposite side of the frame (136), to drive a rotating member (288), such that the band (364) pulls back the lower lip portion (254). As a result, the lower lip portion (254) can likewise be retracted to a specific, predetermined amount by rotating the rotating member (288) accordingly. Similarly, when member (288) rotates in the other direction, it pushes the band (364), and thus, extends the lip outwardly.

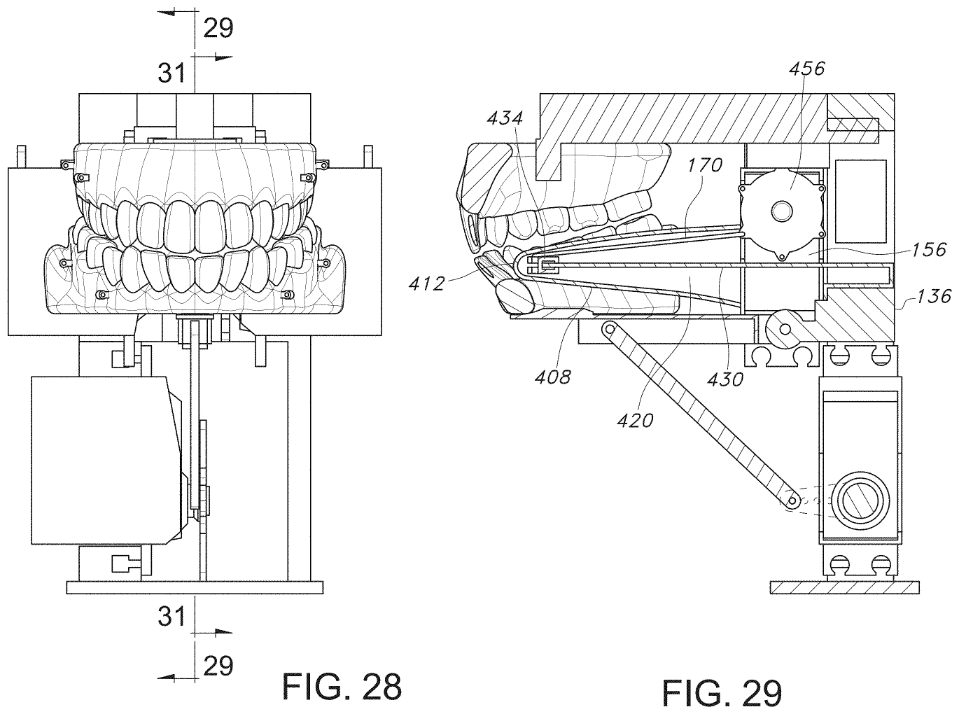

Referring to FIGS. 28-31, the movement of tongue portion (400) is shown. The body of tongue portion (400) has as a blade (408) and a tip (412). A longitudinal channel (420) extends through tongue, which accommodates a flexing band (430), which, in some cases, comprises a spring steel band. The proximal end (432) of the band (430) is mounted to the frame (136), such that the tongue (400) slides over, and is supported by, the band (430).

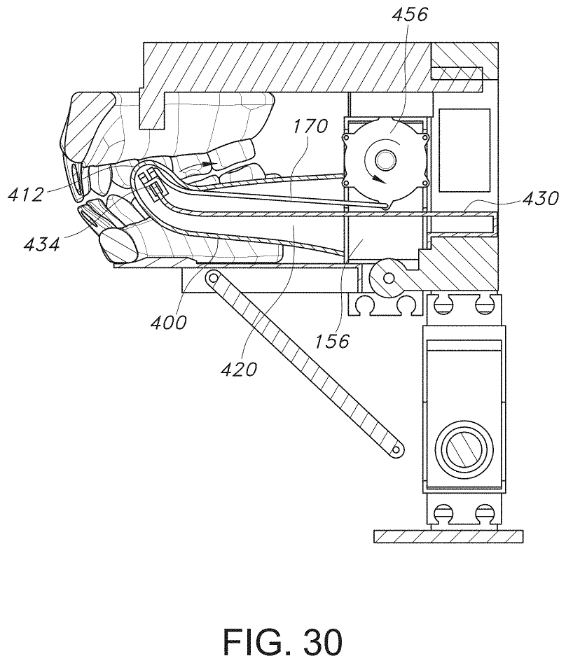

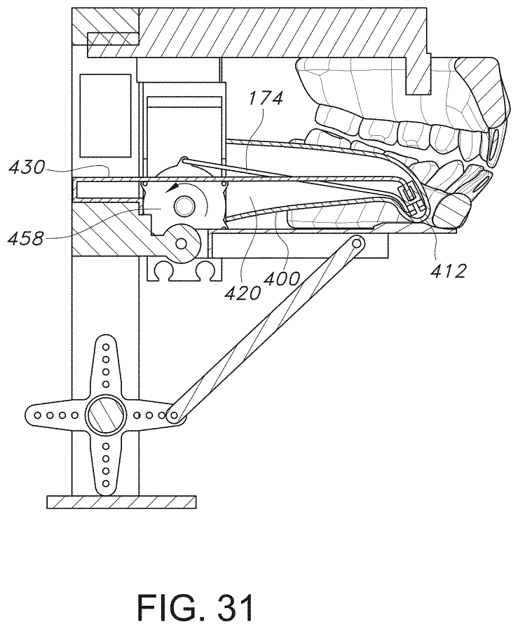

In the illustrated embodiments, the distal end of the band (430) includes a plastic clip (434) with at least one eyelet therethrough. The large servomotor (156) drives a rotating member (456), which is connected to the clip eyelet (438) via a nylon string (170) that runs adjacent the band (430) within the channel (420). As shown in FIG. 30, in order to curl the tongue (400) upward, the servomotor (156) rotates member (456) away from the tongue, pulling on the string (170) and thereby curling the tongue tip (412) upwardly towards the back of the mouth. Similarly, and as shown in FIG. 31, the large servomotor (158) drives a rotating member (458), which is also connected to the clip eyelet via a nylon string (174) that runs adjacent the band (430) within the channel (420). In order to curl the tongue (400) downward, the servomotor (158), which is generally oppositely facing servomotor (156), rotates member (458), pulling on the string (174) and thereby curling the tongue tip (412) downwardly towards the back of the mouth.

The jaw portion (230), upper and lower lip portions (250, 254), and tongue portion (400) are controlled by the control box (132) based upon the requested speech sounds input by a user. In the particular embodiment illustrated in FIG. 7, the control box includes a display (500) that displays a plurality of textual representations of various speech sounds, from which a user can select a desired speech sound to be modeled. These may be mere text, such as an alphabetical list, or may be represented in the form of an icon, in a stylized form and/or accompanied by graphics.

The control box (132) may employ various types of inputs for receiving the speech sound request from the user. For example, the device may include a manual control, such as a knob and/or button (504) for making the desired selection. In some embodiments, the display (500) itself is a touch screen, which the user can use to scroll through the options and make a selection.

In some cases, the control box (132) includes a receiver for wirelessly communicating with a control device. For example, a nearby mobile device (520) may communicate with the control box (132) via Bluetooth® or other wireless protocol, such that a user can use an application on a smartphone or tablet to review and select the relevant speech sounds. In other cases, the control box (132) communicates with a remote device via the Internet (or other network) in cases where the speech therapist is located remotely from the person receiving the speech therapy.

In some embodiments, the selection of the speech sound can be made verbally via speech recognition software.

The control box also includes a processor (540) and an associated memory (550). Stored in the memory (550) are a plurality of motion command sets, each of which corresponds to a particular speech sound. Each motion command set includes one or more commands for moving one or more of the jaw portion (230), upper and lower lip portions (250, 254), and tongue portion (400).

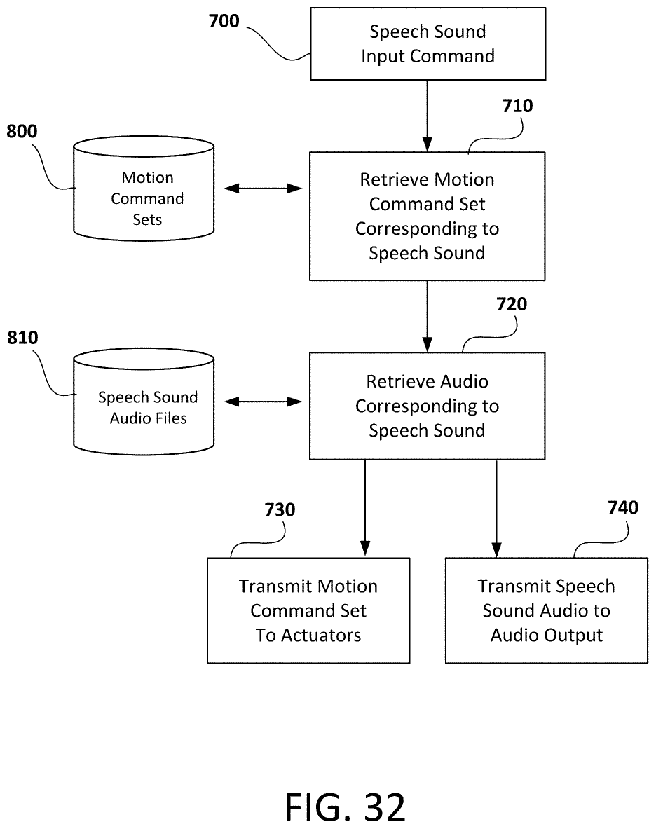

Referring to FIG. 32, once the user selects a particular speech sound via the input, a speech sound input command is communicated (700) to the processor. The processor then retrieves (710) from a motion command set database (800) the motion command set corresponding to that particular speech sound. The processor also retrieves (720) from a speech sound audio database (810) a speech sound recording corresponding to that particular speech sound.

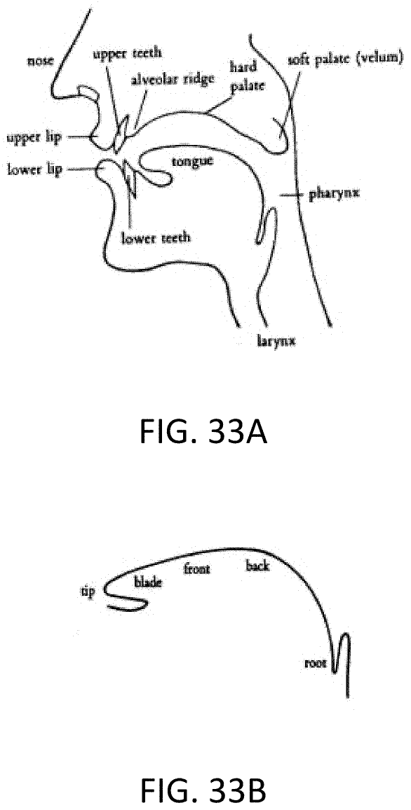

The processor then communicates (730) the retrieved motion commands to the relevant servomotors for moving one or more of the jaw portion, upper and lower lip portions, and tongue portion. Upon receiving the motion commands, the relevant servomotors (150, 152, 156, 158, 162) move one or more of the jaw portion (230), upper and lower lip portions (250, 254), and tongue portion (400) as commanded in order to reflect the proper positioning of the anatomy for that speech sound, which are identified and labelled for ease of reference in FIGS. 33A-B.

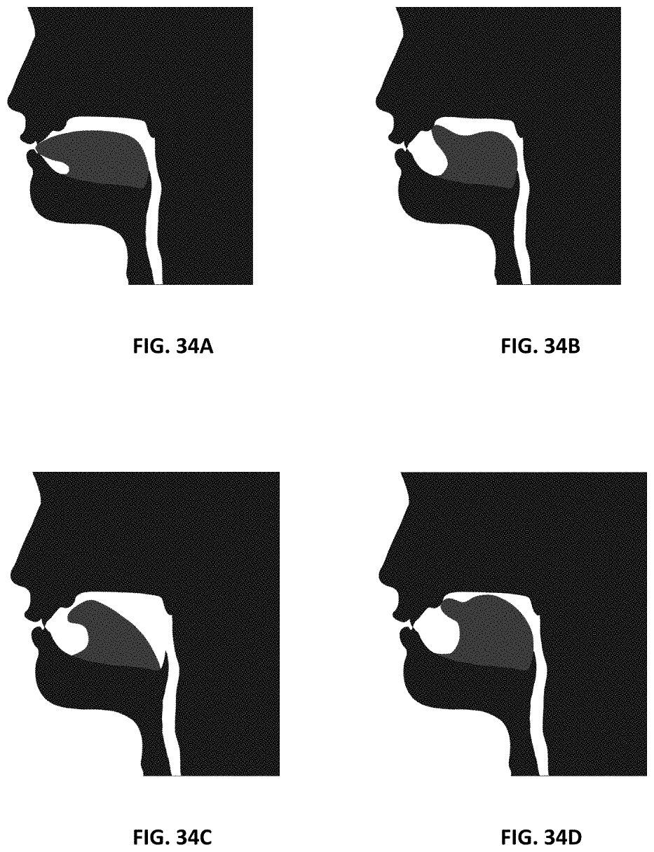

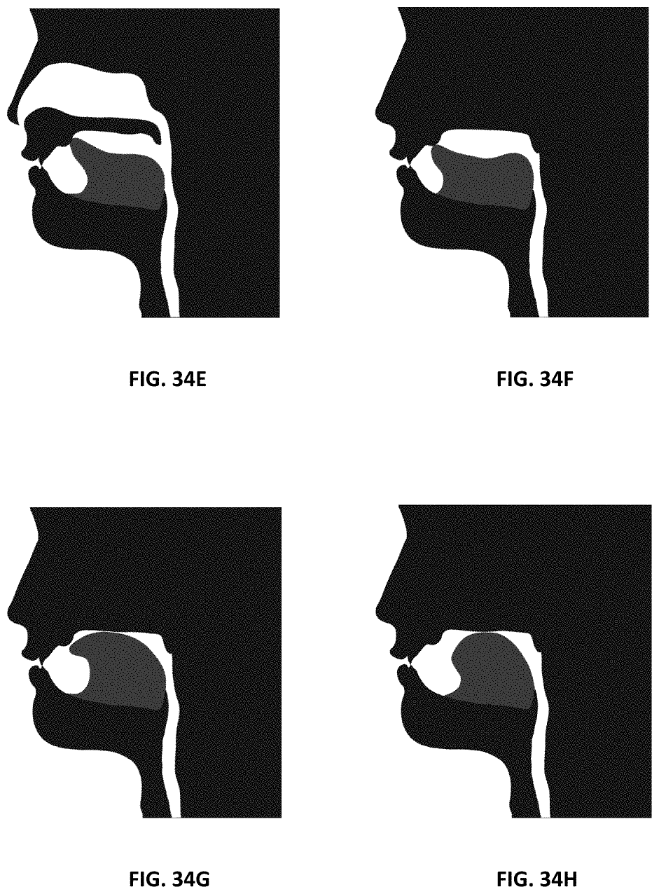

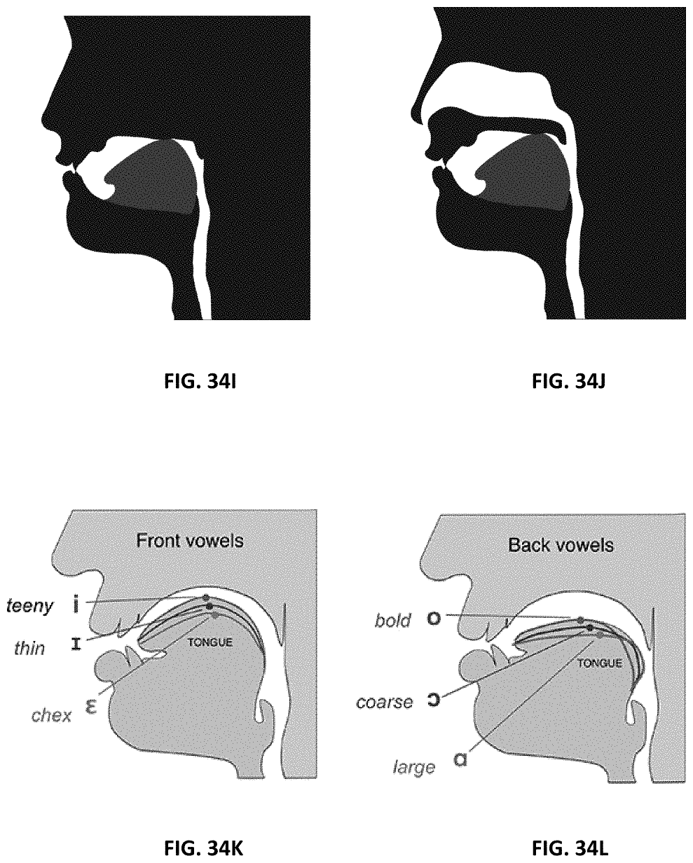

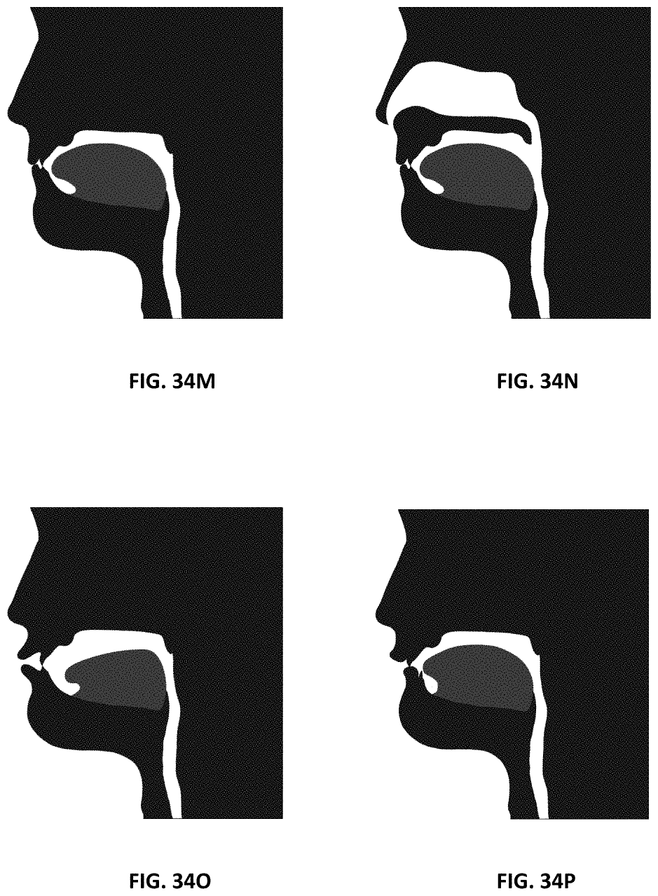

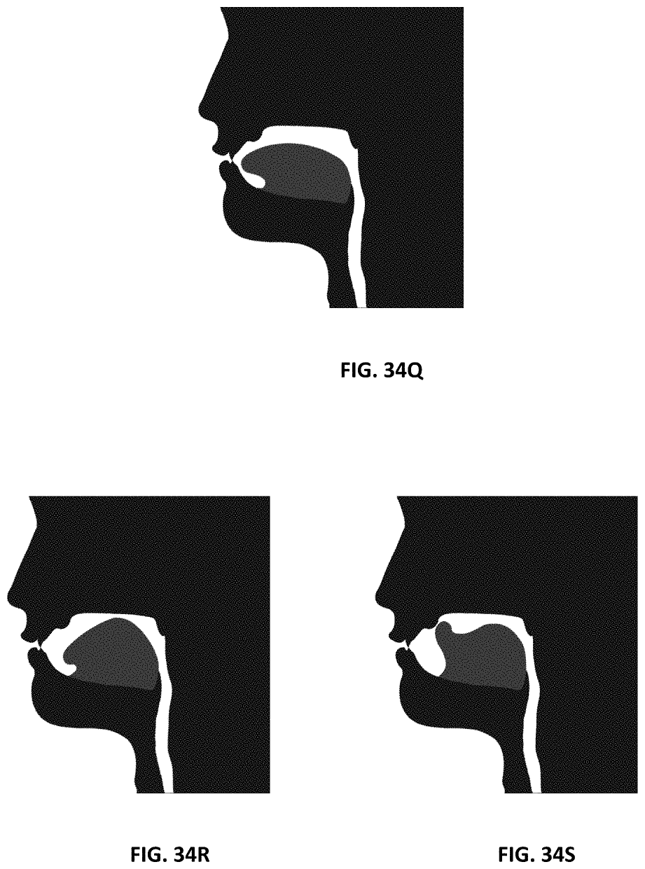

For example, the speech sound representing a “th” (as in “the” or “thin”) is known as an interdental sound. As shown in FIG. 34A, this requires positioning the tip of the tongue (400) between the upper and lower teeth (208, 228).

Another type of speech sound is known as an alveolar sound, which is a sound that is made using the front of the mouth. This requires positioning the end of the tongue (400) on the alveolar ridge (600), which is a bumpy part behind the upper teeth (208). A number of consonants are articulated from this basic position of the tongue with slight positional changes, including: as shown in FIG. 34B, stops (stopping air flow), such as “t” (as in “tap) and “d” (as in “dad”); as shown in FIG. 34C, fricatives (using high pressure air), such as “s” (as in “soup”) and “z” (as in “zoo”); as shown in FIG. 34D, affricates (a stop and a fricative), such as “ch” (as in “chop”) and “j” (as in “jump”); as shown in FIG. 34E, the nasal (through the nose) “n” (as in “no”), and as shown in FIG. 34F, the lateral (air flow around the side of the tongue) “l” (as in “laugh”). As shown, these alveolar sounds themselves have slight positional differences among them. For example, a fricative requires that the tip of the tongue (412) be positioned directly behind the front upper teeth (208), while a lateral requires touching the tip of the tongue (412) to the teeth (208).

Another type of speech sound is known as a palato-alveolar sound, which is also a sound that is made using the front of the mouth, including “sh” (as in “shut”) and “zh” (as in “judge”). However, as shown in FIG. 34G, this requires positioning the blade of the tongue (408) gently against the hard palate (604) and behind the alveolar ridge (600), with the tip of the tongue (412) directly behind the teeth (208).

The speech sound representing a “y” (as in “yo-yo”) is known as a palatal sound. As shown in FIG. 34H, this requires raising the tongue (400) up against the hard palate (604).

Another type of speech sound is known as a velar sound, which are sounds that are made using the back of the mouth. This requires drawing the tongue (400) back to touch the soft palate (612). Several consonants are articulated from this position of the tongue, including: as shown in FIG. 34I, stops, such as “k” (as in “kick”) and “g” (as in “go”), and as shown in FIG. 34J, the nasal “ng” (as in “ring”).

Vowels also require different positions of the tongue (400). For example, to produce front vowels, the tongue (400) is positioned such that the highest point of the tongue is located in the front of the mouth without creating a constriction that would make it a consonant. As illustrated in Fla 34K, this point is at different heights depending on the type of front vowel produced. To produce back vowels, the tongue (400) is positioned such that the highest point of the tongue is located in the back of the mouth without creating a constriction that would make it a consonant. As illustrated in FIG. 34L, this point is also at different heights depending on the type of back vowel produced.

For each of these sounds, the lips are also set in a particular position. In fact, some speech sounds are heavily dependent on the motion of the lips. For example, bilabial sounds are produced using both lips. As shown in FIG. 34M, the stops, including “b” (as in “bee”) and “p” (as in “penny”) require drawing the lips (250, 254) in together, as does the nasal “m” (as in “mom”), as shown in FIG. 34N, while the approximant “w” (as in “wow”) requires pursing the lips, as shown in FIG. 340.

The labio-dental sounds are also produced using the lips in combination with the teeth. As shown in FIG. 34P, these sounds, including “f” (as in “face”) and “v” (as in “vest”), are produced by drawing the lower lip (254) under and in contact with the upper teeth (208).

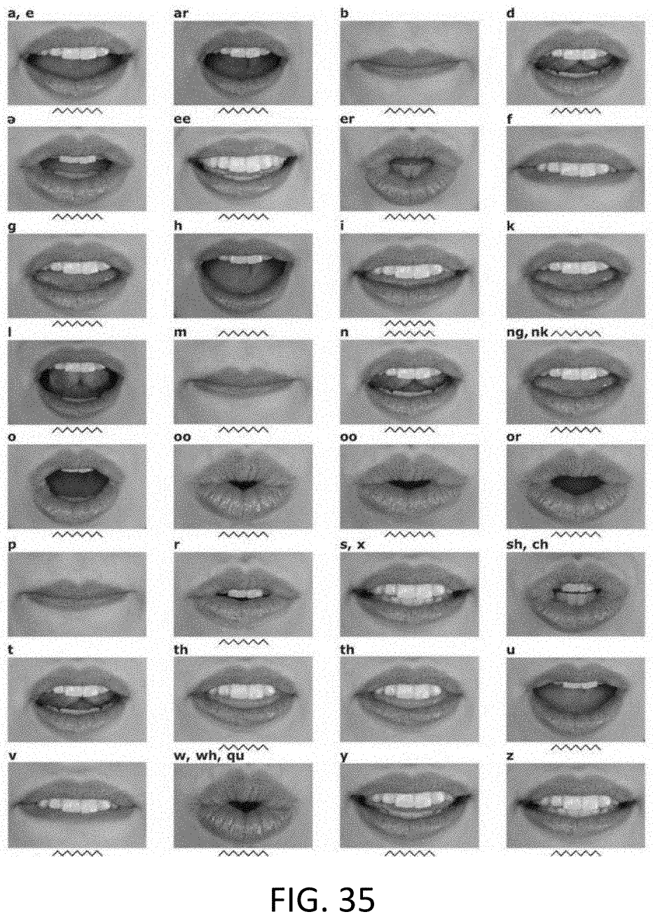

Front views of the specific position of the lips (250, 254) for the various sounds are shown and labelled in FIG. 35.

Similarly, the jaw (230) is controlled based on the degree to which it should be opened for a particular speech sound. Movement of the jaw is mostly dictated by the production of vowel sounds. As previously noted, for both front and back vowel sounds, the highest point of the tongue is positioned at different heights, depending on the particular vowel. The lower the tongue portion (400) is positioned for a given vowel sound, the more open the jaw portion (230) is opened.

It should be noted that certain sounds do not require specific repositioning of the jaw (230), lips (250, 254), and tongue (400) portions. For example, the speech sound representing an “h” (as in “hat”) is known as glottal sound, which is produced by moving the vocal chords and pushing air through them. Therefore, as shown in FIG. 34Q, the jaw (230), lips (250, 254), and tongue (400) portions can be in rest positions.

Moreover, certain sounds can be demonstrated by positioning the jaw (230), lips (250, 254), and tongue (400) portions in different configurations. For example, the “r” sound (as in “red”) can be produced as a bunched R, which, as shown in FIG. 34R, requires retracting the tongue (400) to the back of the mouth, and the side of the tongue are raised to touch the upper teeth (208). Alternatively, the “r” sound can be produced as a retroflexed R, which, as shown in FIG. 34S, requires raising the tongue (400), and curling the tip of the tongue up and back.

Additionally, certain consonants require a combination of the movements described further above. These include “x” (as in “box”), which requires the articulation of the both the “k” and “s” sounds, and “qu” (as in “quit”), which requires the articulation of the both the “k” and “w” sounds.

It should further be noted that variations of the sounds and corresponding positions may vary depending on the particular language in which the speech therapy in being conducted. Accordingly, in certain embodiments, a particular language may be selectable from a plurality of languages using the input (504).

As shown in FIG. 7, the control box (132) also includes an audio output (530). Typically, this will be a speaker in the wall of the control box (132). However, in some cases, other audio outputs may be employed, such as, for example, wirelessly connected headphones worn by the speaker receiving the physical therapy.

Returning to FIG. 32 and as noted above, when the processor receives a speech sound input command and transmits the corresponding motion commands to the relevant servomotors, the processer also retrieves (720) and communicates (740) a corresponding audio recording to the audio output so that that output audibly plays the relevant speech sound when the anatomical parts are moved. In this way, the speaker receiving the therapy is able to hear the proper pronunciation of the sound while observing the proper positioning of the anatomical parts.

In some cases, this audible reproduction of the speech sound will be played multiple times. The number of times it will repeat can either be a predetermined number programmed into the control box, or this number may be selectable using the input (504).

It should be understood that the foregoing is illustrative and not limiting, and that obvious modifications may be made by those skilled in the art without departing from the spirit of the invention. Although the invention has been described with reference to embodiments herein, those embodiments do not limit the scope of the invention. Accordingly, reference should be made primarily to the accompanying claims, rather than the foregoing specification, to determine the scope of the invention.

What is claimed is:

1. A robotic head for modeling the articulation of speech sounds, comprising:
a three-dimensional head section representing the anatomy of at least part of a human head, a moveable tongue portion, moveable upper and lower lip portions, and a moveable jaw portion;
at least one actuator for moving the tongue portion, lip portions, and jaw portion;
a memory storing a plurality of motion command sets, each motion command set comprising a predetermined set of commands for moving one or more of the tongue portion, lip portions, and jaw portion in a manner that corresponds to generation of a speech sound different from the speech sounds corresponding to other of the motion command sets; and
a processor that, in response to receipt of a speech sound input command that identifies a requested speech sound, transmits the commands of the motion command set corresponding to the requested speech sound stored in the memory to the at least one actuator to move one or more of the tongue portion, lip portions, and jaw portion in a manner that corresponds to generation of the requested speech sound;
wherein the three-dimensional head section comprises a transparent material such that the tongue portion is viewable by a patient when moved in response to the at least one actuator receiving the commands of the motion command set corresponding to the requested speech sound.

2. The robotic head of claim 1, wherein the plurality of motion command sets stored in the memory comprises:
a first set of commands for moving one or more of the tongue portion, lip portions, and jaw portion in a manner that corresponds to generation of a first vowel sound;
a second set of commands for moving one or more of the tongue portion, lip portions, and jaw portion in a manner that corresponds to generation of a second vowel sound different from the first vowel sound;
a third set of commands for moving one or more of the tongue portion, lip portions, and jaw portion in a manner that corresponds to generation of a first consonant sound; and
a fourth set of commands for moving one or more of the tongue portion, lip portions, and jaw portion in a manner that corresponds to generation of a second consonant different from the first consonant sound.

3. The robotic head of claim 1, wherein the plurality of motion command sets stored in the memory comprises:
a first set of commands for moving one or more of the tongue portion, lip portions, and jaw portion in a manner that corresponds to generation of a bilabial sound;
a second set of commands for moving one or more of the tongue portion, lip portions, and jaw portion in a manner that corresponds to generation of a labio-dental sound;
a third set of commands for moving one or more of the tongue portion, lip portions, and jaw portion in a manner that corresponds to generation of a inter-dental sound;
a fourth set of commands for moving one or more of the tongue portion, lip portions, and jaw portion in a manner that corresponds to generation of a alveolar sound;
a fifth set of commands for moving one or more of the tongue portion, lip portions, and jaw portion in a manner that corresponds to generation of a post-alveolar sound;
a sixth set of commands for moving one or more of the tongue portion, lip portions, and jaw portion in a manner that corresponds to generation of a palatal sound; and
a seventh set of commands for moving one or more of the tongue portion, lip portions, and jaw portion in a manner that corresponds to generation of a velar sound.

4. The robotic head of claim 1, wherein the plurality of motion command sets stored in the memory comprises two or more of the following:
a set of commands for moving one or more of the tongue portion, lip portions, and jaw portion in a manner that corresponds to generation of a bilabial sound;
a set of commands for moving one or more of the tongue portion, lip portions, and jaw portion in a manner that corresponds to generation of a labio-dental sound;
a set of commands for moving one or more of the tongue portion, lip portions, and jaw portion in a manner that corresponds to generation of a inter-dental sound;
a set of commands for moving one or more of the tongue portion, lip portions, and jaw portion in a manner that corresponds to generation of a alveolar sound;
a set of commands for moving one or more of the tongue portion, lip portions, and jaw portion in a manner that corresponds to generation of a post-alveolar sound;
a set of commands for moving one or more of the tongue portion, lip portions, and jaw portion in a manner that corresponds to generation of a palatal sound; and
a set of commands for moving one or more of the tongue portion, lip portions, and jaw portion in a manner that corresponds to generation of a velar sound.

5. The robotic head of claim 1, further comprising a control box on which the three-dimensional head section is mounted, the control box including:
the memory and the processor therein;
a display that displays a plurality of textual representations of the speech sounds corresponding to the plurality of motion command sets, such that the requested speech sound can be selected from the plurality of textual representations;
an input for generating the speech sound input command that identifies the requested speech sound; and
an audio output for audibly producing the requested speech sound in response to the speech sound input command.

6. The robotic head of claim 5, wherein the input comprises a manual control with which the requested speech sound can be selected from the plurality of textual representations on the display.

7. The robotic head of claim 5, wherein the display comprises a touch screen, the touch screen comprising the input for generating the speech sound input command that identifies the requested speech sound.

8. The robotic head of claim 5, wherein the display also displays an option to select a number of times the speaker will audibly produce the requested speech sound in response to the speech sound input command.

9. The robotic head of claim 1, further comprising:
a control box on which the three-dimensional head section is mounted, the control box having a receiver for wireless communication with a mobile device;
software executing on the mobile device that displays a plurality of textual representations of the speech sounds corresponding to the plurality of motion command sets, such that the requested speech sound can be selected from the plurality of textual representations and, when selected, the speech sound input command that identifies the requested speech sound is transmitted to the control box.

10. The robotic head of claim 9, wherein the software executing on the mobile device also displays an option to select a number of times the requested speech sound will be audibly produced in response to the speech sound input command.

11. The robotic head of claim 1, wherein the at least one actuator comprises:
first and second tongue servomotors coupled to the moveable tongue portion;
first and second lip servomotors coupled to the moveable upper and lower lip portions, respectively; and
at least one jaw servomotor coupled to the moveable jaw portion.

12. The robotic head of claim 11, further comprising:
a control box on which the three-dimensional head section is mounted; and
a support frame connected to the control box, wherein the first and second tongue servomotors, first and second lip servomotors, and at least one jaw servomotor are mounted to the frame.

13. The robotic head of claim 12, further comprising a cover connected to the control box, the cover at least partially enclosing a chamber in which the support frame is disposed.

14. The robotic head of claim 13, wherein the cover is made of an opaque material that obscures the frame, first and second tongue servomotors, first and second lip servomotors, and at least one jaw servomotor from view.

15. The robotic head of claim 13, wherein the cover comprises:
a first portion connected to the control box; and
a second portion hingedly connected to the first portion of the cover such the second portion is moveable from a first position, in which the first and second tongue servomotors, first and second lip servomotors, and at least one jaw servomotor are from hidden from view, to a second position, in which the first and second tongue servomotors, first and second lip servomotors, and at least one jaw servomotor are manually accessible by a user.

16. The robotic head of claim 1, wherein the at least one actuator comprises first and second tongue servomotors, and the moveable tongue portion includes a channel therein, further comprising:
a support frame to which the first and second tongue servomotors are mounted;
a flexing band disposed in the channel, the flexing band having a first end mounted to the support frame, and a second end adjacent a distal end of the tongue portion;
a first string disposed in the channel, the first string having a first end coupled to the first tongue servomotor, and a second end coupled to the second end of the flexing band, such that the tongue moves upwardly when the first tongue servomotor pulls on the first string; and
a second string disposed in the channel, the second string having a first end coupled to the second tongue servomotor, and a second end coupled to the second end of the flexing band, such that the tongue moves downwardly when the second tongue servomotor pulls on the second string.

17. The robotic head of claim 16, wherein the flexing band comprises a spring steel band.

18. The robotic head of claim 1, wherein the at least one actuator comprises first and second lip servomotors, further comprising:
a support frame to which the first and second lip servomotors are mounted;
an upper denture portion and a lower denture portion, each denture portion having a plurality of protuberances along an outer edge thereof, each protuberance having an aperture therein;
an upper flexing band having a first end coupled to the first lip servomotor, the upper flexing band passing through the apertures of the protuberances along the outer edge of the upper denture portion, and having a second end affixed to a proximal end of the upper denture portion, wherein a distal section of the upper flexing band member is affixed to the moveable upper lip portion such that, when the first lip servomotor pulls the upper flexing band member, the upper lip portion is pulled inwardly; and
a lower flexing band having a first end coupled to the second lip servomotor, the lower flexing band passing through the apertures of the protuberances along the outer edge of the lower denture portion, and having a second end affixed to a proximal end of the lower denture portion, wherein a distal section of the lower flexing band member is affixed to the moveable lower lip portion such that, when the second lip servomotor pulls the lower flexing band member, the lower lip portion is pulled inwardly.

19. The robotic head of claim 18, wherein, when the first lip servomotor pushes the upper flexing band member, the upper lip portion is pushed outwardly, and when the second lip servomotor pushes the lower flexing band member, the lower lip portion is pushed outwardly.

20. The robotic head of claim 18, wherein the upper flexing band and the lower flexing band comprise spring steel bands.

21. The robotic head of claim 1, wherein the at least one actuator comprises a jaw servomotor, further comprising:
a support frame to which the jaw servomotor is mounted;
wherein the jaw portion comprises:
a support member pivotably connected to the frame; and
a lower denture portion affixed to the support member; and
wherein the jaw servomotor is coupled to the support member by linkage such that, when the servomotor pulls the linkage, the support member and lower denture portion pivot downwardly.
